(19) United States
(12) Patent Application Publication
(10) Pub. No.: US 2017/0132725 A1
(43) Pub. Date: May 11, 2017

(54) POWER PURCHASING SYSTEM, METHOD THEREOF AND COMPUTER READABLE STORAGE MEDIUM

(71) Applicant: INSTITUTE FOR INFORMATION INDUSTRY, Taipei City (TW)

(72) Inventors: WEI-HSUAN WANG, TAINAN CITY (TW); CHIA-SHIN YEN, TAIPEI CITY (TW)

(21) Appl. No.: 14/958,421

(22) Filed: Dec. 3, 2015

(30) Foreign Application Priority Data
Nov. 6, 2015 (TW) 104136649

(51) Int. Cl. G06Q 50/06; G06Q 30/02; G06Q 10/06

(52) U.S. Cl. CPC G06Q 50/06; G06Q 10/06315; G06Q 30/0206

(57) ABSTRACT

A power purchasing system, a method thereof and a computer readable storage medium are provided. The power purchasing system includes a storage element and a processor. The storage element stores a demanded quantity (indicating the total power to be saved), a projected quantity and an acceptable purchase price of each user. The processor calculates a supply quantity (indicating the power needed to be saved) of each user and a rebate corresponding to the supply quantity according to a present purchase price, a present demanded quantity, a power saving efficiency of each user, a present projected quantity and acceptable purchase price. Accordingly, the user acquires a reasonable rebate by a fair auction and the power generation side saves the needed power by a fair auction similarly.

### BACKGROUND

1. Technical Field

The present invention generally relates to a power purchasing system, a method thereof and a computer readable storage medium and, more particularly, to a power purchasing system with fair determination, a method thereof and a computer readable storage medium.

2. Description of Related Art

Generally, a power purchasing system, a power saving trading platform, is developed by a power generation side (for example, an electric power company) for requesting multiple users (for example, high power-consuming companies) to reduce power consumption during the peak load period. The multiple users may offer the power to be saved as well as their sale prices to the power generation side by auctions. Accordingly, the power generation side replies to each of the users with the power needed to be saved as well as the rebates according to the sale prices so as to reduce power consumption during the peak load period.

However, by such auctions, the sale prices may become lower and lower because of malignant competition and it leads to the loss of the users, which may reduce the fairness and the reliability of the power saving trading platform and may cause hazards of unstable power supply.

### SUMMARY

Accordingly, the present invention provides a power purchasing system with fair determination, a method thereof and a computer readable storage medium, capable of offering each user a reasonable and fair rebate according to the power to be saved by each of the users and the sale prices so as to improve the reliability of the power purchasing system and prevent the hazards of unstable power supply.

One embodiment of the present invention provides a power purchasing method for a power purchasing system. The power purchasing method includes the steps herein. A demanded quantity is determined. A projected quantity determined by each user according to a baseline power consumption and an acceptable purchase price corresponding to the projected quantity is received. A supply quantity of each of the users and a first rebate corresponding to the supply quantity are calculated according to a present purchase price, a present demanded quantity, a power saving efficiency of each of the users, a present projected quantity and the acceptable purchase price. The supply quantity of each of the users is summed up to provide a total supply quantity and whether the total supply quantity reaches the demanded quantity determined is determined. If the total supply quantity reaches the demanded quantity determined, the supply quantity of each of the users is defined as a target quantity. If the total supply quantity does not reach the demanded quantity determined, the total supply quantity is subtracted from the demanded quantity determined to provide a surplus demanded quantity and the supply quantity of each of the users is subtracted from the projected quantity determined of each of the users, respectively, to provide a surplus projected quantity of each of the users so as to calculate a surplus supply quantity of each of the users and a second rebate corresponding to the surplus supply quantity according to the surplus demanded quantity, the acceptable purchase price of each of the users and the surplus projected quantity, to sum up the supply quantity of each of the users and the surplus supply quantity of each of the users to provide a final total supply quantity, and to determine whether the final total supply quantity reaches the demanded quantity determined. If the final total supply quantity reaches the demanded quantity determined, the supply quantity of each of the users and the surplus supply quantity are defined as the target quantity, respectively.

One embodiment of the present invention further provides a power purchasing system. The power purchasing system includes a storage element and a processor. The storage element is configured to store a demanded quantity, a baseline power consumption of each user, a projected quantity of each of the users and an acceptable purchase price corresponding to the projected quantity. The processor is electrically connected to the storage element and is configured to execute the steps herein. The demanded quantity is determined. The projected quantity determined by each of the users according to the baseline power consumption and the acceptable purchase price corresponding to the projected quantity are received. A supply quantity of each of the users and a first rebate corresponding to the supply quantity are calculated according to a present purchase price, a present demanded quantity, a power saving efficiency of each of the users, a present projected quantity and the acceptable purchase price. The supply quantity of each of the users is summed up to provide a total supply quantity and whether the total supply quantity reaches the demanded quantity determined is determined. If the total supply quantity reaches the demanded quantity determined, the supply quantity of each of the users is defined as a target quantity. If the total supply quantity does not reach the demanded quantity determined, the total supply quantity is subtracted from the demanded quantity determined to provide a surplus demanded quantity and the supply quantity of each of the users is subtracted from the projected quantity determined of each of the users, respectively, to provide a surplus projected quantity of each of the users so as to calculate a surplus supply quantity of each of the users and a second rebate corresponding to the surplus supply quantity according to the surplus demanded quantity, the acceptable purchase price of each of the users and the surplus projected quantity, to sum up the supply quantity of each of the users and the surplus supply quantity of each of the users to provide a final total supply quantity, and to determine whether the final total supply quantity reaches the demanded quantity determined. If the final total supply quantity reaches the demanded quantity determined, the supply quantity of each of the users and the surplus supply quantity are defined as the target quantity, respectively.

Furthermore, one embodiment of the present invention further provides a computer readable storage medium capable of storing a computer executable program so that, when the computer readable storage medium is accessed by a processor, the processor executes the computer executable program to implement the steps of the power purchasing method with fair determination.

As stated above, the present invention provides a power purchasing system with fair determination, a method thereof and a computer readable storage medium, capable of offering each of the users a rebate according to the demanded quantity for actual power usage (i.e., the total power to be saved by the power generation side) and the supply quantity (i.e., the power saved by the user). Accordingly, the user acquires a reasonable rebate by a fair auction and the power generation side saves the needed power by a fair auction similarly.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic diagram of a power purchasing system according to one exemplary embodiment of the present invention;

FIG. 2 is a flowchart of a power purchasing method according to one exemplary embodiment of the present invention;

FIG. 3 is a flowchart of calculating a supply quantity and a first rebate of each user according to one exemplary embodiment of the present invention; and

FIG. 4 is a flowchart of calculating a surplus supply quantity of each user and a second rebate corresponding to the surplus supply quantity according to one exemplary embodiment of the present invention.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

The present invention provides a power purchasing system with fair determination, a method thereof and a computer readable storage medium. The power generation side (for example, an electric power company) determines a demanded quantity (indicating the total power to be saved) according to the total power usage. The users (for example, high power-consuming companies) determine a projected quantity (indicating the power that may be saved) and acceptable sale prices according to the actual power usage. The power purchasing system, the method thereof and the computer readable storage medium according to one embodiment of the present invention fairly calculate the required supply power to each user and corresponding rebates according to the information of the power generation side (for example, the present purchase price, the present demanded quantity) and information of the users (for example, the power saving efficiency, the present projected quantity and the acceptable purchase price of each user). Accordingly, the user acquires a reasonable rebate by a fair auction and the power generation side saves the needed power by a fair auction similarly. Herein, the power purchasing system, the method thereof and the computer readable storage medium according to one embodiment of the present invention will be further described.

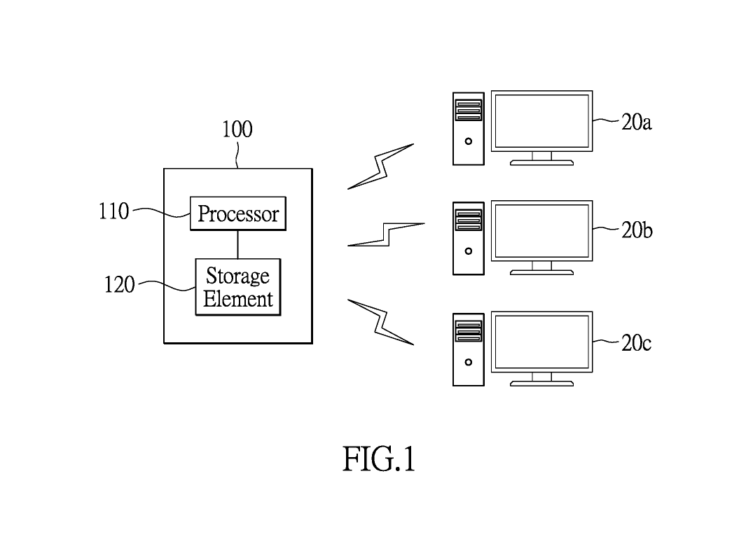

Referring to FIG. 1, FIG. 1 is a schematic diagram of a power purchasing system according to one embodiment of the present invention. In FIG. 1, the power purchasing system 100 is a power saving trading platform with fair determination configured to distribute electric power according to the actual power usage of all the users and requests the users to reduce power consumption by fair auctions. The users save power and acquire reasonable rebates by fair auctions. In the present embodiment, the power purchasing system 100 may be a power generation side, such as an electric power company, or controlled by a remote power generation side, such as an electric power company, through a network. Furthermore, the power purchasing system 100 is electrically connected to multiple computers 20a, 20b and 20c, and each of the computers 20a-20c participates in an auction on the power purchasing system 100 through a network.

The power purchasing system 100 includes a processor 110 and a storage element 120. The processor 110 is electrically connected to the storage element 120 and is configured to execute the steps herein so as to provide the users controlling the computers 20a-20c with corresponding rebates, by the auction, from the power saved. In the present embodiment, the storage element 120 may be volatile or non-volatile memory chips such as a flash memory chip, a read-only memory chip and a random access memory chip. Preferably, the storage element 120 is a non-volatile memory chip.

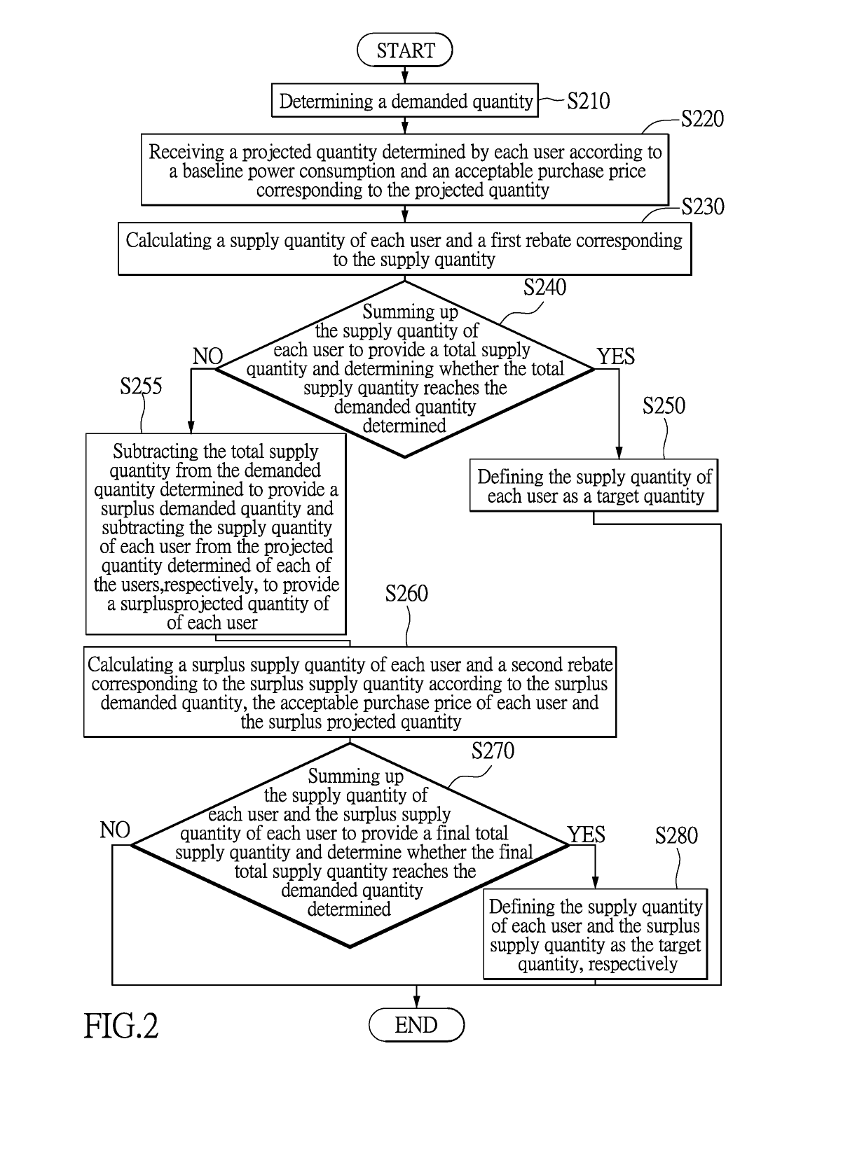

Also referring to FIG. 2, FIG. 2 is a flowchart of a power purchasing method according to one embodiment of the present invention. In Step S210, a demanded quantity is determined. Furthermore, the processor 110 determines the demanded quantity indicating the power needed to be saved according to the power usage of the users. For example, if the demanded quantity is 500, the power generation side requests 500 units of power to be saved and stores the demanded quantity in the storage element 120. Then, in Step S220, the processor 110 receives a projected quantity determined by each user according to a baseline power consumption and an acceptable purchase price corresponding to the projected quantity. The baseline power consumption of each user, the projected quantity and the acceptable purchase price of each user are stored in the storage element 120. This means the user has evaluated the baseline power consumption thereof and determines the power that may be saved (i.e., the projected quantity) and the expected selling price per unit (i.e., the acceptable purchase price).

In the present embodiment, the baseline power consumption corresponds to how the user consumed power before. For example, the baseline power consumption refers to an average power consumption of the user during the past few days. For example, the baseline power consumption refers to the power consumption of the user just one day before. The baseline power consumption may also refer to other information of the user, to which the present invention is not limited.

In the present embodiment, for example, there are 3 users controlling computers 20a-20c, respectively, to determine respective projected quantities and acceptable purchase prices according to the baseline power consumption. For example, user 1 determines that the projected quantity is 300 units and the acceptable purchase price is 1.9 dollars after evaluating the baseline power consumption thereof. User 2 determines that the projected quantity is 400 units and the acceptable purchase price is 3 dollars after evaluating the baseline power consumption thereof. User 3 determines that the projected quantity is 200 units and the acceptable purchase price is 2 dollars after evaluating the baseline power consumption thereof.

After determining the demanded quantity, the projected quantity of each user and the acceptable purchase price, in Step S230, the processor 110 calculates a supply quantity of each user and a first rebate corresponding to the supply quantity according to the present purchase price, the present demanded quantity, a power saving efficiency of each user, the present projected quantity and the acceptable purchase price so that the user saves power and acquires a corresponding rebate by the fair auction. In the present embodiment, the power saving efficiency of each user is an achievement rate indicating the times the target quantity is reached corresponding to the user. For example, if user 1 has participated in the auction 10 times and has reached the target quantity 9 times, the power saving efficiency (i.e., achievement rate) of user 1 is 0.9. For example, if user 2 has participated in the auction 11 times and has reached the target quantity 11 times, the power saving efficiency (i.e., achievement rate) of user 2 is 1. For example, if user 3 has participated in the auction 9 times and has reached the target quantity 8 times, the power saving efficiency (i.e., achievement rate) of user 3 is 0.89.

According to Step S210 to Step S230, the demanded quantities, the projected quantities of the users 1-3, the acceptable purchase prices and achievement rates are included in Table 1.

TABLE 1

| demanded | | acceptable purchase | projected | achievement |
|---|---|---|---|---|
| quantity | user | price | quantity | rate |
| 500 | 1 | 1.9 dollars | 300 | 0.9 |
| | 2 | 3 dollars | 400 | 1 |
| | 3 | 2 dollars | 200 | 0.89 |

Accordingly, the power generation side saves 500-units of power, and the processor 110 of the power purchasing system 100 reasonably calculates the supply quantity of each user and a first rebate corresponding to the supply quantity according to a fair calculation, i.e., according to the present purchase price, the present demanded quantity, a power saving efficiency (i.e., an achievement rate in the present embodiment) of each user, a present projected quantity and the acceptable purchase price.

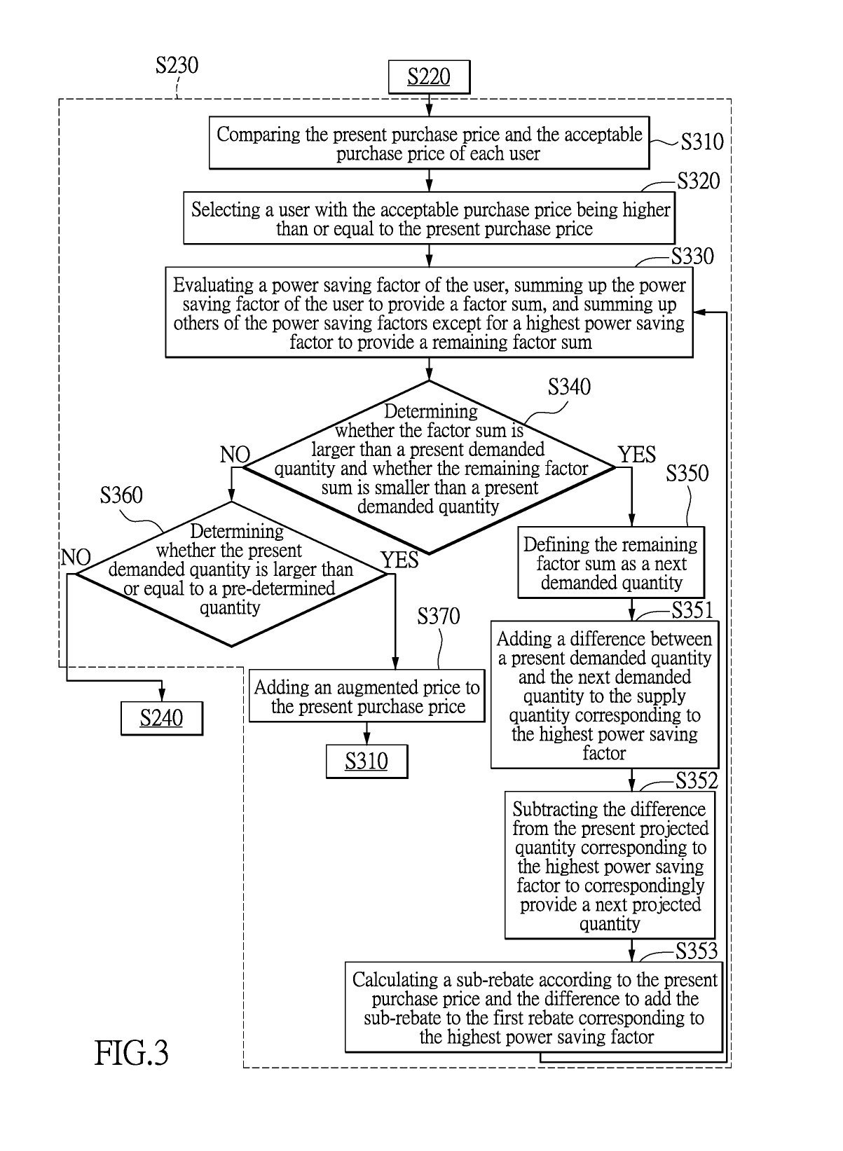

Furthermore, during the calculation of the supply quantity of each user, the steps herein are executed to obtain the supply quantity of each user and the first rebate corresponding to the supply quantity. Referring to FIG. 3, FIG. 3 is a flowchart of calculating a supply quantity and a first rebate of each user according to one embodiment of the present invention. In Step S310, the processor 110 compares the present purchase price and the acceptable purchase price of each user. Then, in Step S320, the processor 110 selects a user with the acceptable purchase price being higher than or equal to the present purchase price so that the user accepts the present purchase price to participate in the calculation as will be described in Step S330.

In Step S330, the processor 110 evaluates a power saving factor of the selected user. The power saving factor may be a projected quantity available to each user at the present purchase price (related to the information of the demanded quantity). In one embodiment, the power saving factor in the step of calculating the supply quantity of each user may be a function of the present purchase price (related to the information of the demanded quantity), the power saving efficiency (i.e., an achievement rate in the present embodiment) of each user, the present projected quantity and the acceptable purchase price (related to the information of the supply quantity). In the present embodiment, the power saving factor may be expressed as:

power saving factor=(achievement rate)*(present projected quantity*acceptable purchase price)/(present purchase price)

For example, in Table 1, if the present purchase price is 3 dollars, the power saving factor of user 1 is 0.9*300*1.9/3=171, the power saving factor of user 2 is 1*400*3/3=400, and the power saving factor of user 3 is 0.89*200*2/3=118.

Next, the processor 110 sums up the power saving factor of each user to provide a factor sum, and sums up the other of the power saving factors except for a highest power saving factor to provide a remaining factor sum. As previously stated, the factor sum is 171+400+118=689. User 2 has the highest power saving factor being 400, and the remaining factor sum is 171+118=289.

Furthermore, in Step S340, the processor 110 further determines whether the factor sum is larger than a present demanded quantity and whether the remaining factor sum is smaller than a present demanded quantity.

If yes, which indicates that at least one of the users is willing to accept the present purchase price, the power purchasing system 100 will sell the user a certain percentage of power (indicating the supply quantity) at the present purchase price, as in Step S350. If not, which indicates that no user is willing to accept the present purchase price, and the power purchasing system 100 will not sell any user the power at the present purchase price, as in Step S360.

In Step S350, the processor 110 defines the remaining factor sum as a next demanded quantity (indicating the surplus demanded quantity). As previously stated, the next demanded quantity becomes 289. Then, in Step S351, the processor 110 adds a difference between a present demanded quantity and the next demanded quantity to the supply quantity corresponding to the highest power saving factor. As previously stated, the difference is 500−289=211 and is added to the supply quantity of user 2, indicating that user 2 is most influential when the present purchase price is 3 dollars. The power purchasing system 100 will sell user 2 a certain percentage of power (indicating the supply quantity) according to the present purchase price and the power saving factor (indicating the influence strength).

Then, in Step S352, the processor 110 subtracts the difference from the present projected quantity corresponding to the highest power saving factor to correspondingly provide a next projected quantity. In Step S353, the processor 110 calculates a sub-rebate according to the present purchase price and the difference to add the sub-rebate to the first rebate corresponding to the highest power saving factor. Step S330 is repeated to evaluate the power saving factor of the selected user according to the updated projected quantity (i.e., the next projected quantity in Step S352) and accordingly determine whether there is any influential user at the same purchase price. In the present embodiment, the sub-rebate may be expressed as:

sub-rebate=present purchase price*difference

As previously stated, the next projected quantity of user 2 is 400−211=189, indicating that the remaining projected quantity of user 2 is 189 and the sub-rebate is 3*211=633 (dollars). Therefore, when the present purchase price is 3 dollars, the remaining projected quantity of user 2 is 189, the supply quantity is 211, and the first rebate is 633 dollars.

From Step S310 to Step S353, the present demanded quantity, the present purchase price, the present projected quantities, the acceptable purchase prices, the achievement rates, the supply quantities and the accumulated rebates of users 1-3 are included in Table 2.

TABLE 2

| | | | acceptable | | | | |
|---|---|---|---|---|---|---|---|
| demanded | purchase | | purchase | projected | achievement | supply | accumulated |
| quantity | price | user | price | quantity | rate | quantity | rebate |
| 289 | 3 dollars | 1 | 1.9 dollars | 300 | 0.9 | 0 | 0 |
| | | 2 | 3 dollars | 189 | 1 | 211 | 633 dollars |
| | | 3 | 2 dollars | 200 | 0.89 | 0 | 0 |

From Table 2, the demanded quantity of the power generation side is 289 units, and the supply quantity of 211-unit power is sold to user 2. Meanwhile, the projected quantity of user 2 becomes 189 (i.e., 400−211=189). The accumulated rebate of user 2 is 633 dollars at the present purchase price being 3 dollars.

In the same case, the processor 110 repeats Step S330 to determine whether there is any influential user at the same purchase price (3 dollars). Meanwhile, the power saving factor of user 1 is still 0.9*300*1.9/3=171, the power saving factor of user 3 is still 0.89*200*2/3=118 and the power saving factor of user 2 becomes 1*189*3/3=189. The factor sum is 171+189+118=478. The highest power saving factor of user 2 is 189, and the remaining factor sum is 171+118=289. The processor 110 determines that the factor sum is larger than the present demanded quantity, and the remaining factor sum is equal to the present demanded quantity, indicating that there is no influential user at the present purchase price. The power purchasing system 100 will not sell any user the power at the present purchase price and further executes Step S360. Meanwhile, the present demanded quantity, the present purchase price, the present projected quantities, the acceptable purchase prices, the achievement rates and accumulated rebates of users 1-3 are as shown in Table 2.

In Step S360, the processor 110 further determines whether the present demanded quantity is larger than or equal to a pre-determined quantity to accordingly determine whether the step of calculating the supply quantity of each user is to be stopped. In the present embodiment, the pre-determined quantity is determined by the power generation side and is stored in advance in the storage element 120. However, the present invention is not limited thereto. Therefore, when the present demanded quantity decreases, through the step of calculating the supply quantity of each user, to a value smaller than the pre-determined quantity (i.e., the present demanded quantity is smaller than pre-determined quantity), the processor stops the step of calculating the supply quantity of each user and further executes Step S240.

Accordingly, if the present demanded quantity is larger than or equal to the pre-determined quantity, the processor 110 adds an augmented price to the present purchase price, and repeats Step S310. In Step S370, the processor 110 determines whether there is any influential user when the augmented price is added to the purchase price. In the present embodiment, the augmented price is determined by the power generation side and is stored in advance in the storage element 120. However, the present invention is not limited thereto.

As previously stated, in the present embodiment, the augmented price is 0.5 dollars. Therefore, the present purchase price increases from 3 dollars to 3+0.5=3.5 dollars. The power saving factor of user 1 is 0.9*300*1.9/3.5=147, the power saving factor of user 2 is 1*400*3/3.5=162, and the power saving factor of user 3 is 0.89*200*2/3.5=102. The factor sum is 147+162+102=411. User 2 has the highest power saving factor being 162, and thus the remaining factor sum is 147+102=249.

The processor 110 determines that the factor sum (i.e., 411) is larger than the present demanded quantity (i.e., 289) and that the remaining factor sum (i.e., 249) is smaller than the present demanded quantity (i.e., 289). Accordingly, the processor 110 executes Step S350-S353. Therefore, the next demanded quantity is 249, the difference between the present demanded quantity and the next demanded quantity is 289−249=40. The next projected quantity of user 2 is 189−40=149, indicating that the surplus projected quantity of user 2 is 149, and the sub-rebate is 3.5*40=140 (dollars). Therefore, when the present purchase price is 3.5 dollars, the surplus projected quantity of user 2 is 149, the supply quantity is 211+40=251, and the first rebate is accumulated to 633+140=773 dollars. The present demanded quantity, the present purchase price, the present projected quantities, the acceptable purchase prices, the achievement rates, the supply quantities and the accumulated rebates of users 1-3 are included in Table 3.

TABLE 3

| | | | acceptable | | | | |
|---|---|---|---|---|---|---|---|
| demanded | purchase | | purchase | projected | achievement | supply | accumulated |
| quantity | price | user | price | quantity | rate | quantity | rebate |
| 249 | 3.5 | 1 | 1.9 dollars | 300 | 0.9 | 0 | 0 |
| | dollars | 2 | 3 dollars | 149 | 1 | 251 | 773 dollars |
| | | 3 | 2 dollars | 200 | 0.89 | 0 | 0 |

From Table 3, the demanded quantity of the power generation side has decreased to 249 units, and the power (indicating the supply quantity) of 251 units of power (i.e., 211+40=251) is sold to user 2. Meanwhile, the projected quantity of user 2 becomes 149 (i.e., 189−40=149). The accumulated rebate of user 2 is 773 dollars at the present purchase price being 3.5 dollars. Next, the processor 110 repeats Step S330 to evaluate the power saving factor of the selected user according to the updated projected quantity (i.e., the next projected quantity in Step S352), and determine whether there is any influential user at the same purchase price.

Therefore, during the calculation of the supply quantity of each user (i.e., Step S230), the processor 110 continuously calculates the supply quantity of each user and the first rebate corresponding to the supply quantity according to the present purchase price, the present demanded quantity, the power saving efficiency (i.e., achievement rate), the present projected quantity and the acceptable purchase price of each user so that the user saves power (i.e., the supply quantity) and acquires the corresponding rebate by a fair auction. Meanwhile, the power generation side saves the needed power (i.e., the demanded quantity) by a fair auction similarly.

Referring to Table 1, the present purchase price, the supply quantity and the accumulated rebate of each user are included in Table 4, which exemplifies the step of calculating the supply quantity of each user. In the present embodiment, the present purchase price starts from 0, and the augmented price is 0.5 dollars. The pre-determined quantity for determining whether to stop the step of calculating the supply quantity of each user is determined to be 47.

TABLE 4

| | | | acceptable | | | | |
|---|---|---|---|---|---|---|---|
| demanded | purchase | | purchase | projected | achievement | supply | accumulated |
| quantity | price | user | price | quantity | rate | quantity | rebate |
| 500 | 0 dollars | 1 | 1.9 dollars | 300 | 0.9 | 0 | 0 dollars |
| | | 2 | 3 dollars | 400 | 1 | 0 | 0 dollars |
| | | 3 | 2 dollars | 200 | 0.89 | 0 | 0 dollars |

First, since the lowest acceptable purchase price among users 1-2 is 1.9 dollars, the processor 110 selects users 1-2 that accept the present purchase price being 2 dollars to participate the calculation in Step S330. Then, the processor 110 calculates the power saving factor of user 1 to be 0.9*300*1.9/2=257, and the power saving factor of user 3 to be 0.89*200*2/2=178. Meanwhile, the processor 110 determines that the factor sum (i.e., 257+178=435) is smaller than the present demanded quantity (i.e., 500), and further determines that the present demanded quantity (i.e., 500) is larger than or equal to a pre-determined quantity (i.e., 47). Therefore, the processor 110 adds an augmented price to the present purchase price so that the purchase price becomes 2.5 dollars and repeats Step S310 to determine whether there is other influential user.

When the purchase price becomes 3 dollars, the processor 110 determines that the factor sum (i.e., 171+400+118=689) is larger than the present demanded quantity (i.e., 500) and the remaining factor sum (i.e., 289) is smaller than the present demanded quantity (i.e., 500). This indicates that there is an influential user, user 2, at the present purchase price being 3 dollars. Then, the processor 110 further executes Step S350 to Step S353 to calculate the next projected quantity (i.e., 189), the present supply quantity (i.e., 211) and the accumulated rebate (i.e., 633 dollars) of user 2. At the present purchase price being 3-3.5 dollars, the demanded quantity of the power generation side, the projected quantities, the supply quantities and the rebates of users 1-3 have been described in Step S310 to Step S370, Table 2 and Table 3, and descriptions thereof are not repeated herein.

Next, the processor 110 continuously executes Step S310 to S370 until the purchase price becomes 13.5 dollars. Meanwhile, the demanded quantity of the power generation side decreases to 46. The processor 110 determines that the present demanded quantity (i.e., 46) is smaller than a pre-determined quantity (i.e., 47) so as to stop calculating the supply quantity of each user, and to further execute Step S240. Meanwhile, the present demanded quantity, the present purchase price, the present projected quantities, the acceptable purchase prices, the achievement rates, the supply quantities and the accumulated rebate of users 1-3, are included as shown in Table 5.

TABLE 5

| | | | acceptable | | | | |
|---|---|---|---|---|---|---|---|
| demanded | purchase | | purchase | projected | achievement | supply | accumulated |
| quantity | price | user | price | quantity | rate | quantity | rebate |
| 46 | 13.5 | 1 | 1.9 dollars | 177 | 0.9 | 123 | 692 dollars |
| | dollars | 2 | 3 dollars | 101 | 1 | 299 | 1027.5 dollars |
| | | 3 | 2 dollars | 171 | 0.89 | 29 | 276.5 dollars |

From Table 5, after the processor 110 calculates the supply quantities and the first rebates corresponding to the supply quantities of each of users 1-3, the present demanded quantity reduces to 46. The supply quantity of user 1 is 123 and the accumulated rebate of user 1 is 692 dollars. The supply quantity of user 2 is 299 and the accumulated rebate of user 2 is 1027.5 dollars. The supply quantity of user 3 is 29 and the accumulated rebate of user 3 is 276.5 dollars. These indicate the power (i.e., the supply quantity) needed to be saved by each of users 1-3 and the rebates (i.e., the accumulated first rebate) of each of users 1-3 corresponding to the power at the present demanded quantity reducing to 46.

Then, referring to FIG. 2, the processor 110 executes Step S240 to sum up the supply quantity of each user to provide a total supply quantity. As previously stated, the total supply quantity is the sum of the supply quantities of users 1-3, i.e., 123+299+29=451. Moreover, the processor 110 determines whether the total supply quantity reaches the demanded quantity determined. In the present embodiment, the standard for determining whether the total supply quantity reaches the demanded quantity determined may be adjusted according to actual conditions. For example, the determined demanded quantity is 500, to which the present invention is not limited.

Meanwhile, if total supply quantity reaches the demanded quantity determined, the processor 110 defines the supply quantity of each user as a target quantity, as in Step S250. In the present embodiment, the processor 110 further informs each user of the corresponding target quantity and the corresponding first rebate. Meanwhile, each user saves power according to the target quantity, and acquires the corresponding first rebate when the saved power reaches the target quantity. The power generation side (for example, the electric power company) is also informed by the power purchasing system 100 of the power needed to be saved by each user and the corresponding first rebate. For example, the demanded quantity determined is 500. Meanwhile, assuming the supply quantity of user 1 is 130 and the accumulated rebate of user 1 is 790 dollars, the supply quantity of user 2 is 330 and the accumulated rebate of user 2 is 1461.5 dollars, and the supply quantity of user 3 is 40 and the accumulated rebate of user 3 is 430.5 dollars, the total supply quantity of users 1-3 is 130+330+40=500, indicating that the total supply quantity reaches the demanded quantity determined. The processor 110 informs, through a network, user 1 that the target quantity is 130 and the corresponding first rebate is 790 dollars, user 2 that the target quantity is 330 and the corresponding first rebate is 1461.5 dollars, and user 3 that the target quantity is 40 and the corresponding first rebate is 430.5 dollars.

If the total supply quantity does not reach the demanded quantity determined, the processor 110 sells all the surplus demanded quantity to users 1-3. Meanwhile, in Step S255, the processor 110 subtracts the total supply quantity from the demanded quantity determined to provide a surplus demanded quantity and subtracts the supply quantity of each user from the projected quantity determined of each of the users, respectively, to provide a surplus projected quantity of each user. Accordingly, the surplus demanded quantity and the power each user can further save can be evaluated.

As previously stated, in the present embodiment, the demanded quantity determined is the demanded quantity, i.e., 500, as first determined by the power generation side. Therefore, the surplus demanded quantity is 500−451=49, indicating that power generation side will sell the surplus demanded quantity being 49 to users 1-3. The surplus projected quantity of user 1 is 300−123=177, the surplus projected quantity of user 2 is 400−299=101, and the surplus projected quantity of user 3 is 200−29=171, indicating the power users 1-3 can further save.

Next, in Step S260, the processor 110 calculates a surplus supply quantity of each user and a second rebate corresponding to the surplus supply quantity according to the surplus demanded quantity, the acceptable purchase price of each user and the surplus projected quantity so as to sell all the surplus demanded quantity to users 1-3.

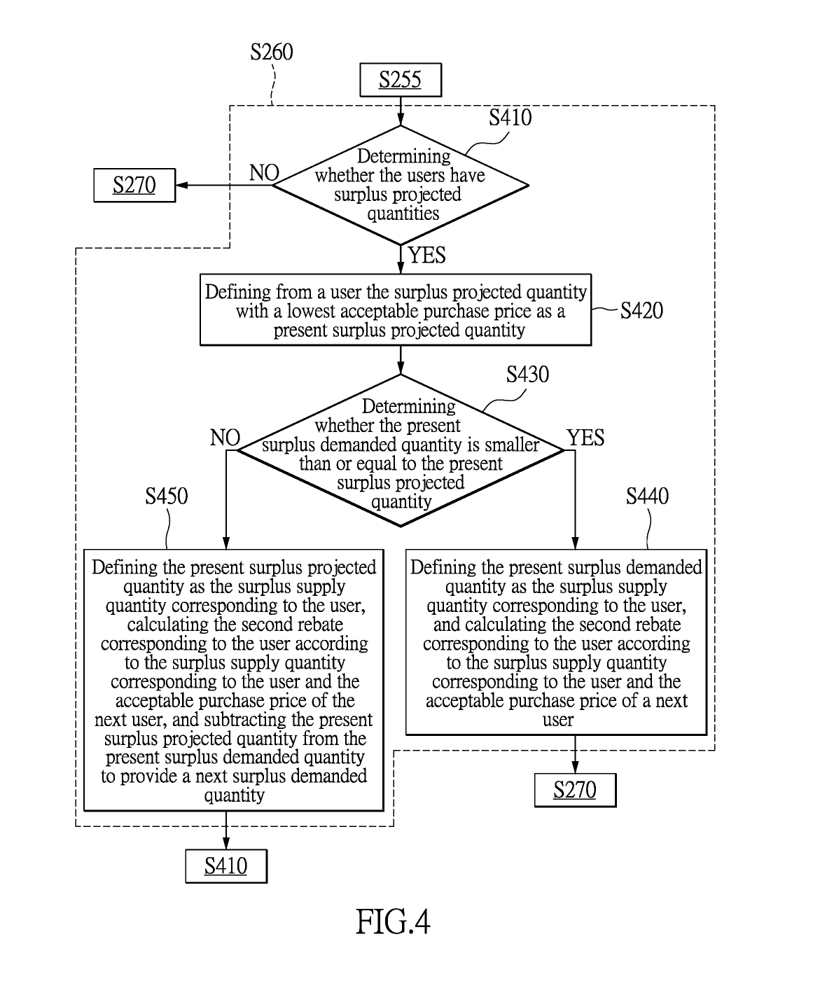

Furthermore, during the calculation of the surplus supply quantity of each user and the second rebate corresponding to the surplus supply quantity, the steps herein are executed to obtain the surplus supply quantity of each user and the second rebate corresponding to the surplus supply quantity. Referring to FIG. 4, FIG. 4 is a flowchart of calculating a surplus supply quantity of each user and a second rebate corresponding to the surplus supply quantity according to one embodiment of the present invention. In Step S410, the processor 110 determines whether the users have surplus projected quantities. If the users do not have surplus projected quantities, it indicates that users 1-3 can no longer save any power and the processor 110 will further execute Step S270. On the contrary, if the users have surplus projected quantities, it indicates that at least one of users 1-3 can save more power. Meanwhile, in Step S420, the processor 110 selects the one from the surplus projected quantities with a lowest acceptable purchase price as a present surplus projected quantity.

As previously stated, the surplus demanded quantity of the power generation side is 49, the surplus projected quantity of user 1 is 177, the surplus projected quantity of user 2 is 101, and the surplus projected quantity of user 3 is 171. Meanwhile, the processor 110 selects the surplus projected quantity of user 1 as a present surplus projected quantity, indicating that user 1 has the lowest acceptable purchase price (i.e., 1.9).

Then, in Step S430, the processor 110 determines whether the present surplus demanded quantity is smaller than or equal to the present surplus projected quantity. If the present surplus demanded quantity is smaller than or equal to the present surplus projected quantity, in Step S440, the processor 110 defines the present surplus demanded quantity as the surplus supply quantity corresponding to the user. The processor 110 calculates the second rebate corresponding to the user according to the surplus supply quantity corresponding to the user and the acceptable purchase price of a next user. Furthermore, the processor 110 further executes Step S270, indicating that the power purchasing system 100 sells all the surplus demanded quantity to the user with the lowest acceptable purchase price. In the present embodiment, the second rebate can be expressed as:

second rebate=surplus supply quantity*acceptable purchase price of next user

As previously stated, the surplus projected quantity of user 1 is 171 as a present surplus projected quantity, and the present surplus demanded quantity is smaller than the present surplus projected quantity. Therefore, the processor 110 defines the present surplus demanded quantity (i.e., 49) as the surplus supply quantity corresponding to the user, and further executes Step S270. Therefore, the surplus supply quantity of user 1 is 98, and the second rebate is 49*2=98 dollars.

On the contrary, if present surplus demanded quantity is larger than the present surplus projected quantity, in Step S450, the processor 110 defines the present surplus projected quantity as the surplus supply quantity corresponding to the user, and calculates the second rebate corresponding to the user according to the surplus supply quantity corresponding to the user and the acceptable purchase price of the next user. Furthermore, the processor 110 subtracts the present surplus projected quantity from the present surplus demanded quantity to provide a next surplus demanded quantity and repeats Step S410.

For example, the present surplus demanded quantity, the present surplus projected quantities and the acceptable purchase prices of users 1-3 are included in Table 6.

TABLE 6

| surplus demanded | | surplus projected | acceptable |
|---|---|---|---|
| quantity | user | quantity | purchase price |
| 50 | 1 | 30 | 1.9 |
| | 2 | 40 | 3 |
| | 3 | 30 | 2 |

The surplus projected quantity of user 1 is 30 and is defined as a present surplus projected quantity. The present surplus demanded quantity is 50. The present surplus demanded quantity is larger than the present surplus projected quantity. Meanwhile, the processor 110 defines the present surplus projected quantity (i.e., 30) as the surplus supply quantity of user 1. The second rebate is 30*2=98 dollars. Meanwhile, the next surplus demanded quantity is 50−30=20, and the surplus projected quantity of user 1 is 0. Next, the processor 110 repeats Step S410 to determine that users 2-3 have surplus projected quantities, being 40 and 30, respectively. Then, the processor 110 defines the surplus projected quantity of user 3 being 30 as a present surplus projected quantity. The present surplus demanded quantity is 20. Meanwhile, the processor 110 determines that the present surplus demanded quantity (i.e., 20) is smaller than the present surplus projected quantity (i.e., 30) and further executes Step S440. Meanwhile, the processor 110 defines the present surplus demanded quantity (i.e., 20) as the surplus supply quantity of user 3 and further executes Step S270. Therefore, the surplus supply quantity of user 3 is 20, and the second rebate is 20*3=60 dollars.

In Step S270, the processor 110 sums up the supply quantity of each user and the surplus supply quantity of each user to provide a final total supply quantity and determine whether the final total supply quantity reaches the demanded quantity determined. If the processor 110 determines that the final total supply quantity reaches the demanded quantity determined, in Step S280, the processor 110 defines the supply quantity of each user and the surplus supply quantity as the target quantity, respectively. In the present embodiment, the processor 110 further informs each user of the corresponding target quantity, the first rebate and the second rebate. Meanwhile, each user can save power according to the target quantity and acquires the corresponding first rebate and the corresponding second rebate when the power saved reaches the target quantity. The power generation side (for example, the electric power company) can also be informed, by the power purchasing system 100, of the power needed to be saved by each user and the corresponding first rebate and the corresponding second rebate. On the contrary, if the processor 110 determines that the final total supply quantity does not reach the demanded quantity determined, the processor 110 stops participating in the auction. Meanwhile, the processor 110 informs each user of an ending message (not shown), indicating that each user fails the auction and users 1-3 do not have any target quantity of saved power.

For example, the demanded quantity determined, the supply quantities, the surplus supply quantities, the first rebates and the second rebates of users 1-3 are included in Table 7. In the present embodiment, the demanded quantity determined is the demanded quantity, i.e., 500, first determined by the power generation side.

TABLE 7

| | | | surplus | | | |
|---|---|---|---|---|---|---|
| demanded | | supply | supply | target | first | second |
| quantity | user | quantity | quantity | quantity | rebate | rebate |
| 500 | 1 | 123 | 49 | 172 | 682 | 98 |
| | | | | | dollars | dollars |
| | 2 | 299 | 0 | 299 | 1027.5 | 0 |
| | | | | | dollars | dollars |
| | 3 | 29 | 0 | 29 | 276.5 | 0 |
| | | | | | dollars | dollars |

Meanwhile, the sum of the supply quantities and the surplus supply quantities of users 1-3 is 123+299+29+49+0+0=500, indicating that the final total supply quantity reaches the demanded quantity determined. The processor 110 informs, through a network, user 1 of the target quantity being 123+49=172, the first rebate being 682 dollars and the second rebate being 98 dollars. The processor 110 informs, through a network, user 2 of the target quantity being 299+0=299 and the first rebate being 1027.5 dollars. The processor 110 informs, through a network, user 3 of the target quantity being 29+0=29 and the first rebate being 276.5 dollars.

As stated above, the power generation side determines a demanded quantity (indicating the total power to be saved) according to the total power usage, and the users determine a projected quantity (indicating the power that may be saved) and acceptable sale prices according to the actual power usage. The power purchasing system 100 fairly calculates the required supply power to each user and corresponding rebates according to the information of the power generation side (for example, the present purchase price, the present demanded quantity) and information of the users (for example, the power saving efficiency, the present projected quantity and the acceptable purchase price of each user). Therefore, in the present invention, the loss of the users due to malignant competitions may be avoided and the fairness as well as the reliability of the power saving trading platform is strengthened to improve power saving and prevent hazards of unstable power supply.

Moreover, the present invention further provides a computer readable storage medium capable of storing a computer executable program containing the foregoing information to implement the steps of the power purchasing method with fair determination. The computer readable storage medium may be a floppy disk, a hard disk, an optical disk, a USB drive, a tape or other storage media of the like that may be accessed through a network.

As stated above, the present invention provides a power purchasing system with fair determination, a method thereof and a computer readable storage medium, capable of offering each of the users a rebate according to the demanded quantity for actual power usage (i.e., the total power to be saved by the power generation side) and the supply quantity (i.e., the power saved by the user). Accordingly, the user acquires a reasonable rebate by a fair auction and the power generation side saves the needed power by a fair auction similarly.

The above-mentioned descriptions represent merely the exemplary embodiment of the present disclosure, without any intention to limit the scope of the present disclosure thereto. Various equivalent changes, alterations or modifications based on the claims of present disclosure are all consequently viewed as being embraced by the scope of the present disclosure.

What is claimed is:

1. A power purchasing method for a power purchasing system, said power purchasing method comprising:
determining a demanded quantity;
receiving a projected quantity determined by each of users according to a baseline power consumption and an acceptable purchase price corresponding to said projected quantity;
calculating a supply quantity of each of said users and a first rebate corresponding to said supply quantity according to a present purchase price, a present demanded quantity, a power saving efficiency of each of said users, a present projected quantity and said acceptable purchase price;
summing up said supply quantity of each of said users to provide a total supply quantity and determining whether said total supply quantity reaches said demanded quantity determined;
defining said supply quantity of each of said users as a target quantity if said total supply quantity reaches said demanded quantity determined;
if said total supply quantity does not reach said demanded quantity determined, subtracting said total supply quantity from said demanded quantity determined to provide a surplus demanded quantity and subtracting said supply quantity of each of said users from said projected quantity determined of each of said users, respectively, to provide a surplus projected quantity of each of said users so as to calculate a surplus supply quantity of each of said users and a second rebate corresponding to said surplus supply quantity according to said surplus demanded quantity, said acceptable purchase price of each of said users and said surplus projected quantity, to sum up said supply quantity of each of said users and said surplus supply quantity of each of said users to provide a final total supply quantity, and to determine whether said final total supply quantity reaches said demanded quantity determined; and
if said final total supply quantity reaches said demanded quantity determined, defining, respectively, said supply quantity of each of said users and said surplus supply quantity as said target quantity.

2. The power purchasing method of claim 1, wherein each of said users is informed of an ending message if said final total supply quantity does not reach said demanded quantity determined.

3. The power purchasing method of claim 1, wherein, in the step of receiving said projected quantity determined by each of said users and said acceptable purchase price corresponding to said projected quantity, said baseline power consumption corresponds to how each of said users consumed power before.

4. The power purchasing method of claim 1, wherein the step of calculating said supply quantity of each of said users further comprises steps of:
comparing said present purchase price and said acceptable purchase price of each of said users;
selecting at least one of said users with said acceptable purchase price being higher than or equal to said present purchase price;
evaluating a power saving factor of said at least one of said users according to said power saving efficiency of said at least one of said users, said present projected quantity, said acceptable purchase price and said present purchase price, summing up said power saving factor of each of said users to provide a factor sum, and summing up the other of said power saving factors except for a highest power saving factor to provide a remaining factor sum;
determining whether said factor sum is larger than a present demanded quantity and whether said remaining factor sum is smaller than a present demanded quantity;
if yes, defining said remaining factor sum as a next demanded quantity, adding a difference between a present demanded quantity and said next demanded quantity to said supply quantity corresponding to said highest power saving factor, subtracting said difference from said present projected quantity corresponding to said highest power saving factor to correspondingly provide a next projected quantity, calculating a sub-rebate according to said present purchase price and said difference to add said sub-rebate to said first rebate corresponding to said highest power saving factor, and repeating the step of evaluating said power saving factor of said at least one of said users;
if not, determining whether said present demanded quantity is larger than or equal to a pre-determined quantity;
if said present demanded quantity is larger than or equal to said pre-determined quantity, adding an augmented price to said present purchase price, and repeating the step of comparing said present purchase price and said acceptable purchase price of each of said users; and
if said present demanded quantity is smaller than said pre-determined quantity, repeating the step of summing up said supply quantity of each of said users to provide said total supply quantity.

5. The power purchasing method of claim 4, wherein said present purchase price starts from 0.

6. The power purchasing method of claim 1, wherein said power saving efficiency of each of said users is an achievement rate indicating the times said target quantity is reached corresponding to each of said users.

7. The power purchasing method of claim 1, wherein the step of calculating said surplus supply quantity of each of said users and said second rebate corresponding to said surplus supply quantity further comprises steps of:
determining whether said users have said surplus projected quantity;
if said users have said surplus projected quantity, defining from one of said users said surplus projected quantity with a lowest acceptable purchase price as a present surplus projected quantity, and determining whether said present surplus demanded quantity is smaller than or equal to said present surplus projected quantity;
if said present surplus demanded quantity is smaller than or equal to said present surplus projected quantity, defining said present surplus demanded quantity as said surplus supply quantity corresponding to said one of said users, calculating said second rebate corresponding to said one of said users according to said surplus supply quantity corresponding to said one of said users and said acceptable purchase price of a next one of said users, and repeating the step of determining whether said final total supply quantity reaches said demanded quantity determined;
if said present surplus demanded quantity is larger than said present surplus projected quantity, defining said present surplus projected quantity as said surplus supply quantity corresponding to said one of said users, calculating said second rebate corresponding to said one of said users according to said surplus supply quantity corresponding to said one of said users and said acceptable purchase price of said next one of said users, subtracting said present surplus projected quantity from said present surplus demanded quantity to provide a next surplus demanded quantity, and repeating the step of determining whether said users have said surplus projected quantity; and
if said users do not have said surplus projected quantity, repeating the step of determining whether said final total supply quantity reaches said demanded quantity determined.

8. A power purchasing system, comprising:
a storage element configured to store a demanded quantity, a baseline power consumption of each of users, a projected quantity of each of said users and an acceptable purchase price corresponding to said projected quantity;
a processor electrically connected to said storage element and configured to execute steps of:
determining said demanded quantity;
receiving said projected quantity determined by each of said users according to said baseline power consumption and said acceptable purchase price corresponding to said projected quantity;
calculating a supply quantity of each of said users and a first rebate corresponding to said supply quantity according to a present purchase price, a present demanded quantity, a power saving efficiency of each of said users, a present projected quantity and said acceptable purchase price;
summing up said supply quantity of each of said users to provide a total supply quantity and determining whether said total supply quantity reaches said demanded quantity determined;
if said total supply quantity reaches said demanded quantity determined, defining said supply quantity of each of said users as a target quantity;
if said total supply quantity does not reach said demanded quantity determined, subtracting said total supply quantity from said demanded quantity determined to provide a surplus demanded quantity and subtracting said supply quantity of each of said users from said projected quantity determined of each of said users, respectively, to provide a surplus projected quantity of each of said users so as to calculate a surplus supply quantity of each of said users and a second rebate corresponding to said surplus supply quantity according to said surplus demanded quantity, said acceptable purchase price of each of said users and said surplus projected quantity, to sum up said supply quantity of each of said users and said surplus supply quantity of each of said users to provide a final total supply quantity, and to determine whether said final total supply quantity reaches said demanded quantity determined; and
if said final total supply quantity reaches said demanded quantity determined, defining, respectively, said supply quantity of each of said users and said surplus supply quantity as said target quantity.

9. The power purchasing system of claim 8, wherein said processor informs each of said users of an ending message if said final total supply quantity does not reach said demanded quantity determined.

10. The power purchasing system of claim 8, wherein said baseline power consumption corresponds to how each of said users consumed power before.

11. The power purchasing system of claim 8, wherein, when said processor calculates said supply quantity of each of said users, said processor compares said present purchase price and said acceptable purchase price of each of said users, selects at least one of said users with said acceptable purchase price being higher than or equal to said present purchase price, evaluates a power saving factor of said at least one of said users according to said power saving efficiency of said at least one of said users, said present projected quantity, said acceptable purchase price and said present purchase price, sums up said power saving factor of each of said users to provide a factor sum, sums up the other of said power saving factors except for a highest power saving factor to provide a remaining factor sum, and determines whether said factor sum is larger than a present demanded quantity and whether said remaining factor sum is smaller than a present demanded quantity;
wherein, if yes, said processor defines said remaining factor sum as a next demanded quantity, adds a difference between a present demanded quantity and said next demanded quantity to said supply quantity corresponding to said highest power saving factor, subtracts said difference from said present projected quantity corresponding to said highest power saving factor to correspondingly provide a next projected quantity, calculates a sub-rebate according to said present purchase price and said difference to add said sub-rebate to said first rebate corresponding to said highest power saving factor, and repeats evaluating said power saving factor of said at least one of said users;
wherein, if not, said processor determines whether said present demanded quantity is larger than or equal to a pre-determined quantity;
wherein, if said present demanded quantity is larger than or equal to said pre-determined quantity, said processor adds an augmented price to said present purchase price, and repeats comparing said present purchase price and said acceptable purchase price of each of said users; and
wherein, if said present demanded quantity is smaller than said pre-determined quantity, said processor sums up said supply quantity of each of said users to provide said total supply quantity, and determines whether said total supply quantity reaches said demanded quantity determined.

12. The power purchasing system of claim 8, wherein said power saving efficiency of each of said users is an achievement rate indicating the times said target quantity is reached corresponding to each of said users.

13. The power purchasing system of claim 8, wherein, when said processor calculates said surplus supply quantity of each of said users and said second rebate corresponding to said surplus supply quantity, said processor determining whether said users have said surplus projected quantity;
wherein, if said users have said surplus projected quantity, said processor defines from one of said users said surplus projected quantity with a lowest acceptable purchase price as a present surplus projected quantity, and determines whether said present surplus demanded quantity is smaller than or equal to said present surplus projected quantity;
if said present surplus demanded quantity is smaller than or equal to said present surplus projected quantity, said processor defines said present surplus demanded quantity as said surplus supply quantity corresponding to said one of said users, calculates said second rebate corresponding to said one of said users according to said surplus supply quantity corresponding to said one of said users and said acceptable purchase price of a next one of said users, and determines whether said final total supply quantity reaches said demanded quantity determined;
if said present surplus demanded quantity is larger than said present surplus projected quantity, said processor defines said present surplus projected quantity as said surplus supply quantity corresponding to said one of said users, calculates said second rebate corresponding to said one of said users according to said surplus supply quantity corresponding to said one of said users and said acceptable purchase price of said next one of said users, subtracts said present surplus projected quantity from said present surplus demanded quantity to provide a next surplus demanded quantity, and determines whether said users have said surplus projected quantity; and
if said users do not have said surplus projected quantity, said processor determines whether said final total supply quantity reaches said demanded quantity determined.

14. The power purchasing system of claim 8, wherein said power purchasing system is electrically connected to a plurality of computers, each of said plurality of computers determining, through a network, said projected quantity corresponding thereto and said acceptable purchase price corresponding thereto.

15. A computer readable storage medium, wherein said computer readable storage medium stores a computer executable program so that, when said computer readable storage medium is accessed by a processor, said processor executes said computer executable program to implement the steps of claim 1.
